(19) United States
(12) Patent Application Publication
(10) Pub. No.: US 2024/0075706 A1
(43) Pub. Date: Mar. 7, 2024

(54) Durable Mycelium Bonding

(71) Applicant: MycoWorks, Inc., Emeryville, CA (US)

(72) Inventor: Matthew L. Scullin, Emeryville, CA (US)

(21) Appl. No.: 18/241,806

(22) Filed: Sep. 1, 2023

Related U.S. Application Data
(60) Provisional application No. 63/403,279, filed on Sep. 1, 2022.

(51) Int. Cl. B32B 9/02; B29C 43/20

(52) U.S. Cl. CPC B32B 9/02; B29C 43/203; B29K 2001/00

(57) ABSTRACT

A method for stitchless bonding of fungal materials includes providing a waste-sourced mycelium substrate sourced from fermentation waste streams, selecting a plurality of waste-sourced mycelium substrate portions to be bonded, applying a pressure activated adhesive layer between the selected portions of the waste-sourced mycelium substrate, agglomerating the selected portions of the waste-sourced mycelium substrate and bonding the selected portions of the waste-sourced mycelium materials together to form a durable bond without delamination. Thus, the waste-sourced mycelium substrate is biodegradable which serves as a sustainable alternative to animal leather or synthetic leather in various applications.

### PRIORITY

This application claims priority from the United States provisional application with Ser. No. 63/403,279, which was filed on Sep. 1, 2022. The disclosure of that provisional application is incorporated herein as if set out in full.

### BACKGROUND OF THE DISCLOSURE

### Technical Field of the Disclosure

The present embodiment relates generally to methods for stitchless bonding of fungal materials and more particularly, to a method for processing waste-sourced materials and bonding those waste-sourced materials together to exhibit improved properties such as waterproofing, durability and tensile strength.

### Description of the Related Art

Today's population is becoming increasing concerned with protecting the environment from pollution, minimizing waste generation, and controlling natural resource depletion. The practice of business as usual on material production is not creating a circular economy. Fungal-based composites are the recently implemented technology that promotes the concept of the circular economy, which is a regenerative economic system that aims to minimize resource waste and maximize the utilization of materials throughout their lifecycle. Unlike the traditional linear economy, which follows a “take-make-dispose” pattern, the circular economy focuses on reducing the consumption of finite resources, minimizing environmental impact, and fostering sustainable growth. Mycelium has thus emerged as a suitable biomaterial applicant in the field of construction, manufacturing, agriculture, textile and biomedical. Mycelium is mainly composed of natural polymers, making it a perfect alternative to non-biodegradable materials like synthetic leather. Conventionally, in order to use the mycelium, the mycelium is subjected to chemical treatments making it durable and resistant to environmental stress.

It is also now commonplace for textile industries to manufacture biodegradable leather as an alternative to animal leather and synthetic leather. Synthetic leather uses hazardous chemicals in its production and are derived from fossil fuels, reducing their biodegradability. Animal leathers are produced from tanning the skins of animals; however, the tanning process generally involves toxins such as chromium resulting in further environmental stress. Vegan leather from mycelium is biodegradable and serves as a sustainable alternative to animal leather in various applications.

Another conventional method that describes fungal derived materials is limited by the capacity of liquid or submerged cultures in the propagation of filamentous hyphae, which are then harvested and cultivated on secondary scaffolds and incubators. To overcome this, numerous methods and systems have been used for the large-scale production of composites grown with mycelium, but conventional methods do not allow for the easy manipulation of growing fungal hyphae to produce materials with desired qualities like tensile strength, elasticity, durability etc. Yet, another conventional method describes reduced processing of fungal tissue materials, with the resulting outcome exhibiting poor mechanical characteristics when dry, particularly exhibiting low flexibility and high brittleness.

There thus remains a need for improvements to material production using non-biodegradable materials. Such methods would provide a mycelium material sourced from fermentation waste streams that would eliminate waste and utilize the biomaterials within waste. Further, such a method would exhibit improved properties like waterproofing, durability, and tensile strength. Such a method would not involve toxic protein-based crosslinking, which is commonly used in the creation of animal-based leather products. Moreover, such a method would eliminate all upstream operations found in animal leather such as dehairing and defatting thereby reducing the carbon footprint of the production process. Further, such a method could be modified in various ways to suit different applications without departing from its principles and concepts. Similarly, there is a need for a method that would attach a portion of mycelium-based material to one or more additional portions of mycelium-based materials without the need for sewing, stitching, stapling, or other mechanical means. Moreover, such a needed method would minimize or reduce environmental problems in the manufacturing, recycling, or disposal phase of the mycelium composite. The present embodiment overcomes the shortcomings in the field by accomplishing these critical objectives.

### SUMMARY OF THE INVENTION

To minimize the limitations found in the prior art, and to minimize other limitations that will be apparent upon the reading of the specification, the preferred embodiment of the present invention provides a bonded fungal material composite including a plurality of waste-sourced mycelium substrates, a bonding agent for crosslinking the plurality of waste-sourced mycelium substrates thereby providing a durable bond between each of the plurality waste-sourced mycelium substrates, a mold in the form of a panel for determining a geometric shape of the plurality of waste-sourced mycelium substrates, the mold being incubated thereby allowing the plurality of waste-sourced mycelium to form a waste-sourced mycelium network that binds each of the plurality of waste-sourced mycelium substrates and the bonding agent together, solidifying slowly into the geometric shape of a plurality of waste-sourced mycelium substrates being cast within, an adhesive layer for bonding the plurality of waste-sourced mycelium substrates within itself thereby enabling the formation of a solid continuous mycelium layer the waste-sourced mycelium substrates and a drying chamber for enabling the dehydration of the plurality of waste-sourced mycelium substrates in a bonded state thereby retarding further growth of the plurality of waste-sourced mycelium substrates. In the present embodiment, the bonding agent does not expose to degradation thereby allowing durable and long-lasting bond between the plurality of waste-sourced mycelium substrates resulting in a stronger and more resilient bonded fungal material composite.

In the preferred embodiment, the bonding between the plurality of waste-sourced mycelium substrates does not require any mechanical means to hold the plurality of waste-sourced mycelium substrates together. Also, the plurality of waste-sourced fungal material composite is carbohydrate-based as the plurality of waste-sourced fungal material composite does not rely on the oils or other organic compounds that causes delamination. Further, in this embodiment the method for creating stitchless bonding of fungal composite is used for producing durable mycelium-based products, including but not limited to apparel, accessories, footwear, furniture, sporting goods, electronic devices, and automotive interiors, without the need for sewing, stitching, stapling, or other mechanical means.

The preferred embodiment provides a method for creating stitchless bonding of fungal material composite. The method commences by providing a plurality of waste-sourced mycelium substrates. Next, processing the plurality of waste-sourced mycelium substrates into a desiccation process, that allows removing excess moisture from the plurality of waste-sourced mycelium substrates. Then, mixing the plurality of waste-sourced mycelium substrates with a bonding agent in a mold and subjecting to a heating and pressing process to form a plurality of waste-sourced fungal material composite. Next, applying an adhesive layer to the plurality of waste-sourced fungal material composite thereby enabling the formation of a solid continuous layer of the plurality of waste-sourced fungal material composite. Thereafter, forming the plurality of waste-sourced fungal material composite into a desired shape by applying a heat and pressing process to the plurality of waste-sourced fungal material composite. Then, enabling dehydration to prevent further growth of the plurality of waste-sourced fungal material composite utilizing a drying chamber.

A first objective of the present invention is to provide a mycelium material sourced from fermentation waste streams that eliminate waste and utilizing the biomaterials within waste.

A second objective of the present invention is to provide a method that exhibits improved properties like waterproofing, durability and tensile strength.

A third objective of the present invention is to provide a method that does not involve toxic protein-based crosslinking, which is commonly used in the creation of animal-based leather products.

A fourth objective of the present invention is to eliminate all upstream operations found in animal leather such as dehairing and defatting thereby reducing the carbon footprint of the production process.

A fifth objective of the present invention is to provide a method that can be modified in various ways to suit different applications without departing from its principles and concepts.

Another objective of the present invention is to provide a method in which a portion of mycelium-based material is being attached to one or more additional portions of mycelium-based materials without the need for sewing, stitching, stapling, or other mechanical means.

Yet another objective of the present invention is to provide a method that does not cause any environmental problems in manufacturing, recycling or disposal phase of the mycelium composite.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to. Furthermore, elements that are known to be common and well understood to those in the industry are not depicted in order to provide a clear view of the various embodiments of the invention, thus the drawings are generalized in form in the interest of clarity and conciseness.

FIG. 1 shows a block diagram of a process involved in creating stitchless bonding of fungal material composite according to the preferred embodiment of the present invention;

FIG. 2 shows a perspective view of the mixture of the plurality of waste-sourced mycelium and the bonding agent according to the preferred embodiment of the present invention;

FIG. 3 shows a perspective view of the waste-sourced fungal material composite according to the preferred embodiment of the present invention; and

FIG. 4 shows a flowchart for a method for creating stitchless bonding of fungal material composite according to the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

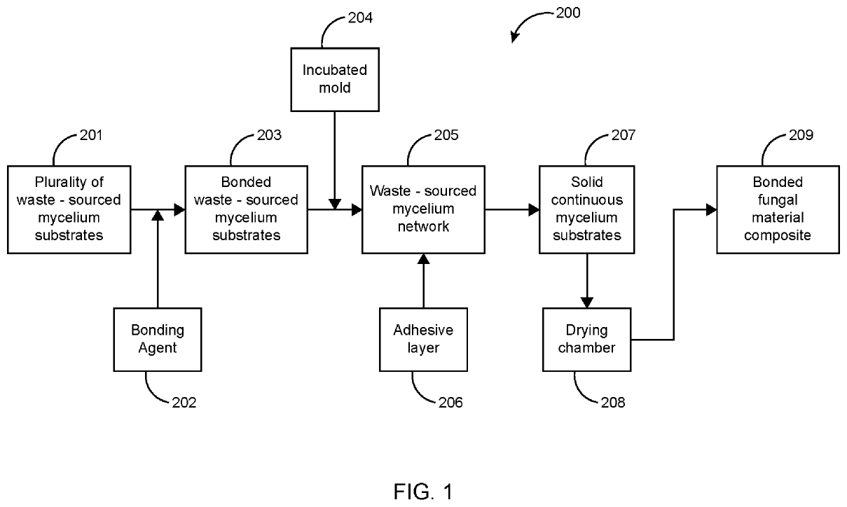

Referring to FIG. 1, the preferred bonding of fungal material composite 200 comprises a plurality of waste-sourced mycelium substrates as indicated at block 201, a bonding agent as indicated at block 202 for crosslinking the plurality of waste-sourced mycelium substrates 201 thereby providing a durable bond between each of the plurality waste-sourced mycelium substrates 201, a mold in the form of a panel for determining a geometric shape of the plurality of waste-sourced mycelium substrates, the mold being incubated as indicated at block 204 thereby allowing the plurality of waste-sourced mycelium substrates 201 to form a waste-sourced mycelium network as indicated in block 205 that binds each of the plurality of waste-sourced mycelium substrates 201 and the bonding agent 202 together, solidifying slowly into the geometric shape of a plurality of waste-sourced mycelium substrates 201 being cast within, an adhesive layer 206 for bonding the plurality of waste-sourced mycelium substrates 201 within itself thereby enabling the formation of a solid continuous mycelium layer of the waste-sourced mycelium substrates 201 and a drying chamber 208 for enabling the dehydration of the plurality of waste-sourced mycelium substrates 201 in a bonded state thereby retarding further growth of the plurality of waste-sourced mycelium substrates 201. In the present embodiment, the bonding agent 202 does not expose to degradation thereby allowing durable and long-lasting bond between the plurality of waste-sourced mycelium substrates resulting in a stronger and more resilient bonded fungal material composite 209.

The mycelium materials are sourced from fermentation waste streams (e.g., enzyme fermentation waste streams), thus eliminating waste and utilizing the biomaterials within waste. Using a proprietary fermentation processes, a byproduct waste stream is produced comprising a mycelium byproduct. The result is a cellulose-based material that is useful for a variety of functions including self-adhesion of mycelium products. In the preferred embodiment, the bonding agent 202 signifies the cellulose-based material that provides self-adhesion of mycelium products. This cellulose-based, mycelium-infused product is not only useful for self-adhesion of mycelium products, but it also benefits from a superior hand-feel to other plant matter leather, due to prevalence of hyphal cells and their branching. This results in an improvement in softness and drape of the finished material. This preferred embodiment 200, eliminates all upstream operations found in animal leather such as dehairing and defatting. Animal-based products also create a significant carbon footprint, which is not a problem with the lubricating and/or fat liquoring steps involved in the sourcing of the materials described herein. Finally, unlike animal leather, this is not a protein-based leather, so toxic protein-based crosslinking is not involved in the creation of the source material.

As shown in FIG. 1, the plurality of waste-sourced mycelium substrates and the bonding agent combines to form a bonded waste-sourced mycelium substrate as shown in block 203. Next, as indicated at block 204 the incubated mold allows the plurality of waste-sourced mycelium to form a waste-sourced mycelium network as shown in block 205. As indicated in block 206 the adhesive layer for bonding the plurality of waste-sourced mycelium substrates within itself thereby enabling the formation of a solid continuous mycelium layer of the waste-sourced mycelium substrates as shown in block 207. In this embodiment, a variety of bonding processes can be used, including but not limited to applying a heat or pressure activated adhesive layer in between portions of mycelium-based materials, as well as various agglomerated methods, high-frequency welding, and the like. These processes collectively are referred to as “stitchless bonding” or “durable bonding”. Stitchless bonding of mycelium-based materials can be used in the production of consumer products such as apparel (e.g., leather-like clothing), accessories (e.g., briefcases, purses), footwear, furniture, sporting goods, electronic devices, and automotive interiors. Next, as indicated at block 208 a pressure activated adhesive layer is applied to the plurality of waste-sourced fungal material composite thereby forming a geometric shaped bonded waste-sourced fungal material composite as indicated at block 209.

In this embodiment, the plurality of waste-sourced mycelium substrates 201 is desiccated and processed into a desiccated mycelium powder form or other suitable form for mixing with the cellulose-based material. Further, in the present invention a portion of mycelium-based material is attached to one or more additional portions of mycelium-based materials without the need for sewing, stitching, stapling, or other mechanical means typically seen in leather goods. In some embodiments, a durable bond is created between the portions, allowing for multi-piece construction of finished or semi-finished consumer products. In other embodiments, a durable bond comprises heat-bonded, pressure bonded, or chemically bonded materials. In the preferred embodiment, MP is a leather-like fabric and comprises a wide range of viscosities from as low as 100 cps to in excess of 1,750,000 cps (preferably ranging from 200 cps to in excess of 1,500,000 cps).

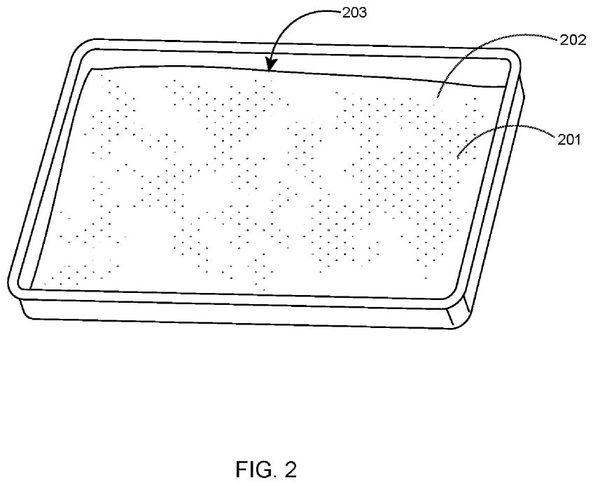

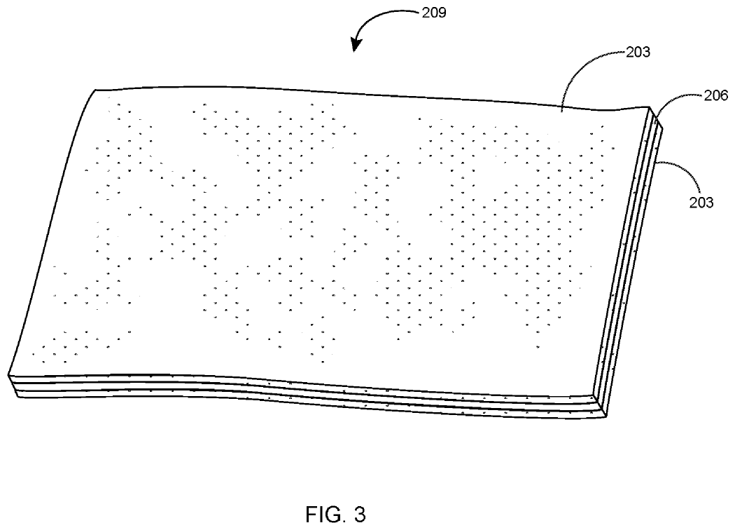

As shown in FIG. 2, the plurality of waste-sourced mycelium substrates 201 and the bonding agent 202 combines to form a bonded waste-sourced mycelium substrate 203. Next, a pressure activated adhesive layer 206 is applied to the bonded waste-sourced mycelium substrate 203 thereby forming a geometric shaped bonded waste-sourced fungal material composite 209 as shown in FIG. 3.

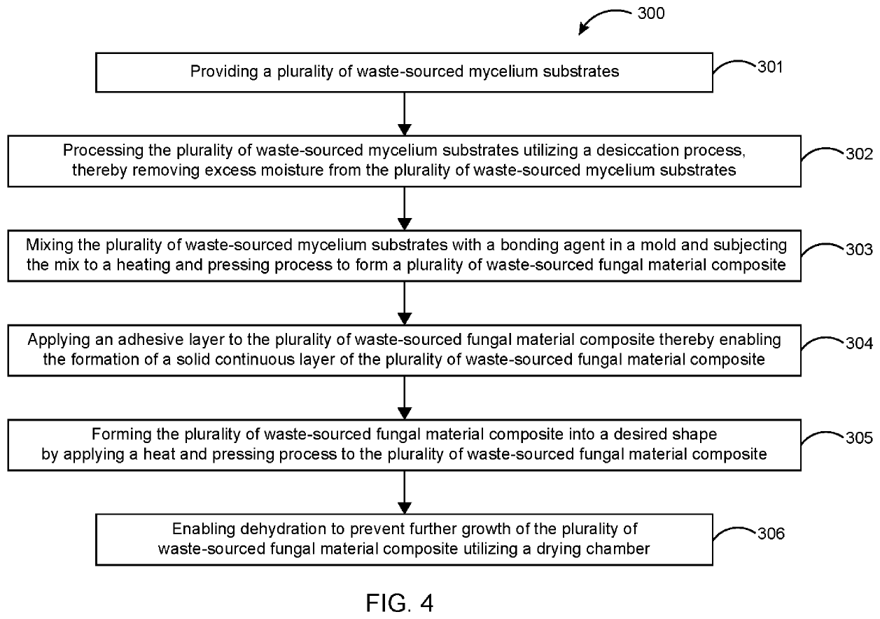

FIG. 4 is a flowchart of a method for creating stitchless bonding of fungal material composite 300. The method commences by providing a plurality of waste-sourced mycelium substrates as shown in block 301. Next, processing the plurality of waste-sourced mycelium substrates into a desiccation process, thereby removing excess moisture from the plurality of waste-sourced mycelium substrates as shown in block 302. Then, the plurality of waste-sourced is mixed with mycelium substrates using a bonding agent in a mold and subjecting to a heating and pressing process to form a plurality of waste-sourced fungal material composite as shown in block 303. Next, applying an adhesive layer to the plurality of waste-sourced fungal material composite thereby enabling the formation of a solid continuous layer of the plurality of waste-sourced fungal material composite as shown in block 304. Thereafter, forming the plurality of waste-sourced fungal material composite into a desired shape by applying a heat and pressing process to the plurality of waste-sourced fungal material composite as shown in block 305. Then, enabling dehydration to prevent further growth of the plurality of waste-sourced fungal material composite utilizing a drying chamber as shown in block 306.

In some embodiments, the mixed product (MP) is a leather-like fabric which is taken in a liquid form and applied as a paste to a substrate backer such as fabric or leather. Then a binder is added to the paste. The binder comprises an enzyme, resin, or polymer. The binder includes a material that when dried facilitates formation of a solid continuous layer with favorable texture (e.g., similar to leather) which is uniquely composed of carbohydrate mycelium materials (MM). The bound MP material and/or related products is placed into a high frequency welding machine for further processing of the leather. Notably, the above described process may preferably take place in a vacuum drum. In an alternative embodiment binder is added to the processed paste to modulate the rigidity of the paste.

In some embodiments, the present invention provides a method to self-adhere mycelium via an adhesive layer, heat-formed methods, or agglomerated methods (AM) (e.g., pressed methods, dehydrated methods, covalent methods, and the like). In certain embodiments, AM comprises mycelium agglomerates (MA) (e.g., covalently bound MM, ionically bound MM, Van Der Waals bound MM, dehydrated MM, etc.), mycelium covalent agglomerates (MCA) (e.g., covalent binding between MM particles), mycelium ionic agglomerates (MIA) (e.g., ionic binding of agglomerates), mycelium heated agglomerates (MHA) (e.g., heat press, heat formed methods), and Van Der Waals agglomerates (VDW; MM binding via Van Der Waals forces), and mycelium resonance agglomerates (MRA) (e.g., resonance-stabilized agglomerates). Notably, in certain embodiments, heat-pressing and covalent agglomeration is shown to enhance homogeneity, strength, and stiffness of mycelium composite material. Notably, heat-pressed mycelium materials have similar density and elastic modulus as natural materials (e.g., cork and wood). When these methods are processed with leather resulting in sticking and delamination due to the oils contained in the leather. This improvement over leather and synthetic leather results, in part, from a high concentration of carbohydrates in the mycelium materials versus primarily proteins in analogous leather products. If desired to improve texture or appearance, carbohydrates may be affixed to two bonded segments of fungal materials after the two segments of fungal materials are attached to each other via the above-described methods. In other words, carbohydrate compounds may be used with the attached fungal materials, for example via chemical modification by standard methods (e.g., protonation with acid solutions, deprotonation with basic solutions, covalent modifications, glycosidic bond substitutions, and the like).

As described above, the use of MP pastes and the methods described herein result in a superior hand-feel relative to other plant matter leather, due to hyphal cells and their branching units. For example, after bonding, said branched hyphal cells result in an improvement in softness and drape including a softness level of 5 out of 5 (e.g., a “soft temper” on the standard leather temper scale). The superior hand-feel of the herein described products also results from unique primary, secondary, and tertiary materials that may be added to the hyphal cells. For example, secondary materials may be incorporated into the fungal mycelium to further create structural connections, mechanical reinforcements, and interfacings within and on the surface of the molded fungal shape that improve hand-feel. Secondary materials may be inserted partially from one surface to the middle or can fully pierce the sample along any desired axial path. These reinforcements can also change skin densities, reinforce adhesion, structurally reinforce assembly components, and create building elements with interfaces and connection points that include incorporated fixturing and fastening elements.

In other alternative embodiments, MP pastes may also comprise a liquid, a spray, an emulsion, a gas, a solid, and the like. In some embodiments, MP can be heat treated (e.g., heated MIA or MHA agglomerate) or cured at room temperature. MP may penetrate a given surface or remain on the surface. MP can also be impregnated with fats, oils, emulsions, or other additives that impart water resistance. In another embodiment, MP is in powder form that can be mixed with other materials such as secondary powders, polymers or resins to form a secondary mixture. Said secondary mixture may be used to form a plant-based leather, bio-based leather, and the like via drying. Said drying can be carried out via spray drying, heating, or evaporation. In certain embodiments, the end result is a material that might have similar textural properties to Rhenoflex® (e.g., Rhenoflex GmbH), polyurethane leather (PU Leather), and other synthetic leathers known in the art. Said resulting product has a high bio content, a lower carbon footprint than synthetic leathers, and improved texture and durability relative to synthetic leathers known in the art. In certain embodiments, all upstream operations typically used in synthetic leather production are eliminated (e.g., dehairing and defatting steps are eliminated).

In other alternative embodiments, drapability on synthetic leathers is employed. The drape is one of the important properties associated with garment or synthetic leather fitness quality and appeal. Notably, the independent variables flexural rigidity and thickness affect the dependent variable drapability.

Fungi are both strong and flexible as well as capable of synthesizing a wide range of enzymes, oxidative compounds, alcohols, and other caustic chemical agents that can break the strong hydrogen bonds, resulting in a more flexible, drapable product. As indicated, the mycelium products (MP) do not comprise a protein-based leather. Thus, standard protein-based crosslinking is not required, meaning that no tannins, chromium, or other toxic adulterants are used in chrome tanning. In certain embodiments, the above process for durable mycelium bonding may be considered a method of lubrication (known as fatliquoring).

The mycelium material (MM) is the broadest term used herein to describe fungal materials. MM encompasses all of the fungal materials described herein. In certain embodiments, an organism such as aspergillum is used to ferment a substrate to produce a mycelium byproduct (MB) (e.g., mycelium dehydrated sludge, or slurry) MB and a primary byproduct (PB) (e.g., the primary end product used by industry such as citrus acid). The term mixed product (MP) refers to a MB mixed with secondary materials. Secondary materials may be incorporated into the fungal mycelium to further create structural connections, mechanical reinforcements, and interfacings within and on the surface of the molded fungal shape that improve hand-feel. Secondary materials may also be inserted partially from one surface to the middle or can fully pierce the sample along any desired axial path.

In some alternate embodiments, the hyphal cells of the fungal mixed products (MP) described herein may be intact and embedded between the proximal areas of plastic. In certain embodiments, the hyphal cells comprise about 50% of the total area of the product (e.g., 50% hyphal cells, and 50% total proximate plastic). In other embodiments, the hyphal cells comprise a broader range (e.g., 5-90% of the total area). Said percentages are tunable by varying growth conditions including water, nutrients, light, and the like. As described, a primary advantage is the ability to use waste mycelium. Notably existing mushroom or mycelium leather products require expensive, dedicated growth of the fungus typically using an expensive primary substrate material.

In alternative embodiments, the mycelium byproduct (MB) and/or mixed product (MP) may be formed into particles with a range of particle sizes and a range of hyphal branching attributes (length of hyphae branches, number of bifurcation and branching events per hyphae, hyphae diameter, and the like). Particalized (e.g., powderized, or the like) MB or MP for use in self-adhering systems may take on a broad range including small (0.5-2 mm), medium (2-4 mm) and large (>4 mm-7 mm). At the microscale, the hyphae comprising the microstructure of the mycelium powder or slurry have a diameter typically ranging from 3-8 μm. They may be genetically modified via standard methods (e.g., CRISPER, or common molecular biology techniques) to expand and/or contract this diameter between 0.1 μm and 50 μm. Hyphae branch length may range from 2 μm to 200 μm in the preferred embodiment. Hyphae branching events can take on a wide variety, ranging from zero branching events to hundreds of branching events per length of individual hyphae. In some embodiments, MP or MB is desiccated to form a powder (see above) that can be mixed with a secondary powder (e.g., other polymers or resins) and turned into a plant-based leather, or a bio-based leather. Said drying can be achieved by spray drying, heating, evaporation, or the like. As a result, the end product achieves a feel and flexibility similar to Rhenoflex GmbH, polyurethane leather (PU Leather), or animal leather.

Notably, hypha consists of one or more cells surrounded by a tubular cell wall. In most fungi, hyphae are divided into cells by internal cross-walls called septa. Septa are usually perforated by pores large enough for ribosomes, mitochondria, and sometimes nuclei to flow between cells. The major structural polymer in fungal cell walls is typically chitin, in contrast to plants and oomycetes that have cellulosic cell walls. Some fungi have a septate hyphae, meaning their hyphae are not partitioned by septa. These microstructures may be manipulated by the above described genetic engineering methods to enhance adhesion strength between mycelium units, or to modulate the hand-feel of the units. Since the particles comprising MB and/or MP are biological structures, users can utilize standard molecular biology techniques to improve their adhesion properties, their response to heat, chemical treatments, and the like.

The above-described particles or powders may be formed into an adhesive layer as described above in order to adhere two separate units of mycelium together. Once adhered, these separate mycelium units may be used to form various fungal molded shapes, wherein the fungal molded shapes comprise larger secondary and tertiary structures taking on a variety of three-dimensional shapes. Said fungal molded shapes may be joined together and adhered to one another to form an organic weld between any given numbers of fungal molded shapes. Adhering two fungal molded shapes is accomplished by stationing one on top of the other while the MP and/or MB material is wet, that is, before it has dried out. Once connected, the fungal molded shapes may be left alone in a nominally controlled environment, until a strong bond is formed. Although the fungal molded shapes take the form of individual shapes, a set of fewer or more separate fungal units can similarly be used to form a structure.

The self-adhesive techniques described herein are adaptable to a wide variety of fungi, including yeasts, rusts, smuts, mildews, molds, and mushrooms. The self-adhesive techniques are also adaptable to fungus-like organisms, including slime molds and oomycetes (e.g., water molds). Preferably, strains (e.g., Ganoderma) used in an industrial setting are related to enzymatic production. These strains vary individually in water content (10-80%), viscosity, and other standard variables. The MP and MB products may be further modified with cross linkers, resins, plastics, polymers, precursors, monomers, and/or curatives.

Various processes are contemplated to make and apply the self-adhesive mycelium system. These processes include mixing, casting, and bi-casting approaches. For example, a casting method may involve placing incubating fungal units (self-adhered with MP and MB) into a mold in the form of a panel wherein incubation occurs for several days. During the incubation period the inoculated self-adhered fungal substrates form a mycelial network that binds the materials together, slowly solidifying into the shape of the form it was cast within. After incubation, the entire mixture may be dried so that further fungal growth is retarded. The finished panel product exhibits the characteristics of the original materials it was grown from (such as the strength or thermally insulating qualities of the fibers), which are now “glued” together by the fungus, in addition to MP and MB. Further methods contemplated include screen-printing, continuous deposition on a roll, roll-to-roll process (e.g., applying one unit to another), and in situ mixing while being cast.

In addition to its strength and durability, dried fungus and/or sludge-sourced powdered MP and MB products have many other beneficial qualities: low toxicity, shear strength, fire-resistance, mold resistance, water-resistance, and high thermal insulation. In other embodiments, MP and MB may be filtered and decanted before further processing. These steps can help to ensure homogeneity of microparticles used in subsequent processing steps. Said homogeneity can be important in the construction of finer materials such as leather substitutes and other materials wherein control of the appearance and tensile characteristics is of high concern.

Notably, sludge-sourced powdered MP and MB products can also be processed with less energy and materials than conventional manufacturing and can be processed using filtering and heating steps that contribute to good stewardship of renewable resources. In addition, sludge-sourced powdered MP and MB products benefit from enhanced safety profiles for users of MP and MB products. In particular, MP and MB products are free of pathogens, microbial activity, and are not a source of viable microbial cells. This sterilized state is achieved through various steps, particularly powderizing, filtering, and desiccating steps. Desiccation of sludge-sourced powdered MP and MB prevents any living organisms from proliferating and replicating. Filtering removes any macroparticles or other life forms that may use sludge as an energy source. Finally, since the powderizing step (also referred to as “powdering” step) involves processing at elevated temperatures, the desiccated starting materials are subjected to high heat, thereby denaturing any remaining cellular structures, such as cell walls, macromolecular proteins, and the like. This step ensures that any desiccation-resistant life forms such as spores, or toxic proteins capable of surviving desiccation, are denatured and rendered harmless to a user via the above-described processing steps.

In other embodiments, crosslinking may be utilized with MP and MB to form a resin that traps the mycelium. Resin-encased mycelium can be used to enhance the rigidity of self-bonding mycelium systems and to modify flex. In some embodiments, standalone hyphae are surrounded and enveloped by a crosslinked or partially crosslinked polymer plastic resin. In certain embodiments, the polymer plastic resin percolates through the entire crosslinked system such that a contiguous continuous structure is formed that envelopes the hyphae in a two phase mixture. As shown in Table 1, in some embodiments a variety of crosslinking compounds, links (e.g., Link A and/or Link B from table 1), and bonding sites can be interspersed to form a variety of crosslinked and partially crosslinked structures.

In some embodiments, crosslinking methods are applied to MP and MB-bonded leather-like fungus-based materials or composites with the aim of increasing tensile strength, tear strength, flexibility, and other desirable qualities within that material. Notably, the present structures and methods control the chemical and mechanical properties of fungal materials and their composites for applications in textiles, packaging, building materials, and other industries where such materials are utilized. The physical crosslinking of fungal material is achieved by chemically linking the branched, filamentous fibers contained in fungal material. The strands of mycelium (e.g., hyphae) comprise spaghetti-like strands made of chitin.

In some embodiments, a self-adhered crosslinked fungal composite material includes acetamide groups on the chitin chain. Said acetamide groups may be targeted for modification via various means. In certain embodiments, the acetamide groups on the chitin are utilized to create a bonding site for compounds that attach through an amide bond. Compounds that attach through an amide bond include glutaraldehyde, metal-complex tannins, and synthetic tannins (“syntans” or “syntan compounds”). In some embodiments, the acetamide groups are deacetylated into amine groups. Notably, deacetylated chitin is also referred to as chitosan. These modifications can be used to improve MB and MP self-adherence and hand-feel.

Another embodiment comprises a crosslinked fungal composite self-adhered with MP or MB wherein the links are created by phenolic compounds such as vegetable tannins, among polysaccharides (sugar molecules) which exist on the hyphal cells. Such a crosslinked fungal material exhibits links between bonding sites on the hydroxyl groups of the polysaccharides. These polysaccharide bonding sites may also be on the cellulosic material that is used as the composite along with the fungal material, such as a cotton textile layer. As described above, links may also be created by the partial degradation of chitin molecules into chitosan followed by a reaction with genipin.

Another embodiment of the present invention utilizes bonding sites on the carbonaceous backbone of the chitin molecule itself. Binding to the carbonaceous backbone may be achieved by various methods known to persons skilled in the art and as described herein. Further embodiments of the present invention comprise combinations of the above bonding mechanisms, wherein a crosslinking compound or molecule acts as a bridge between dissimilar bonding sites, resulting in crosslinked chitin or chitosan fibers. Bonding between dissimilar bonding sites may include but are not limited to hydroxyl to carbon bonding, hydroxyl to amine bonding, carbon to carbon bonding, carbon to amine bonding, and the like.

A summary of distinct embodiments of crosslinked fungal composites is provided in Table 1 below:

TABLE 1

| Crosslinking | | | |
|---|---|---|---|
| Compound or | | | |
| Molecule | Link A | Link B | Bonding-site |
| Glutaraldehyde | Chitin and/or | Chitin and/or | Hydroxyl and/or |
| (condensation) | Polysaccharide | Polysaccharide | Amine Groups |
| Vegetable Extract | Polysaccharide | Polysaccharide | Hydroxyl Groups |
| (phenolic or | and/or Chitin | and/or Chitin | |
| polyphenolic | | | |
| compounds) | | | |
| Syntans (synthetic | Chitin and/or | Chitin and/or | Amine Groups |
| tannins) | Polysaccharide | Polysaccharide | |
| Metal Complex | Deacetylated | Deacetylated | Carboxyl Groups |
| (Mineral) | Chitin | Chitin | |
| Genipin | Deacetylated | Deacetylated | Amine Group on |
| | Chitin | Chitin | Chitosan |
| Carbon-Carbon | Carbon | Carbon | Covalent |
| Bonding | | | |

Table 1 shows that chitin-containing and/or polysaccharide-containing compositions may include crosslinking compounds attached to bonding sites. If a bonding site comprises, for example, a hydroxyl group and/or an amine group, then a glutaraldehyde crosslinking compound may serve as a suitable crosslinking molecule. Also, if a hydroxyl group bonding site is present, then phenolic compounds such as those found in vegetable extracts may serve as a suitable crosslinking molecule. Another embodiment illustrated in Table 1 involves an amine group bonding site. If an amine group bonding site is present, then a syntan compound (synthetic tannins) may serve as a suitable crosslinking molecule.

In another embodiment, as illustrated in Table 1, a carboxyl group bonding site is present. If a carboxyl group bonding site is present, then a metal complex may serve as a suitable crosslinking molecule. In addition, covalent carbon-carbon bonds may be formed using carbonaceous linker segments. As described in Table 1, various combinations of the above-described crosslinking compounds and bonding sites are contemplated in the present invention. Further to the above, crosslinking may be facilitated by a secondary constituent and a tertiary crosslinking compound. Said tertiary compound may form a crosslink between the fungal material and the secondary constituent. While said fungal material crosslinks to the secondary constituent, it may also crosslink to itself. Similarly, the secondary material may crosslink to itself. Finally, the tertiary compound may agglomerate into larger, polymeric chains that are then bonded to the fungal material and/or the secondary constituent. In certain embodiments, the mycelium may also be crosslinked to itself while capturing an embedded material within it.

In some embodiments, self-adhered and/or crosslinked mycelium subunits may be combined to form structures adapted to survive 7,000-20,000 Bally flexural cycles on a Bally Flexometer (e.g., a tensile strength greater than ˜1 MPa) and to achieve a softness level of 5/5 (e.g., soft temper). In another embodiment, the self-adhered and/or crosslinked mycelium subunits may survive 800-1,500 Martindale abrasion cycles and more than 5-20 wet Veslic abrasion cycles (preferably 8 wet Veslic abrasion cycles).

In certain embodiments, MB dehydrated sludge or slurry is obtained from the remains of industrial processing, for example from the remains of the fruit juice industry, or the like. The use of mycelium waste as a source material provides for several advantages relative to comparable source materials (e.g., apple skins). For example, mycelium provides for improved rigidity and degradation properties relative to comparable apple-skin sourced products. In addition, the mycelium waste byproduct provides for improved softness and drape. Another advantage of the invention is the elimination of all upstream operations found in animal leather such as dehairing and defatting. Animal-based products also create a significant carbon footprint, which is not a problem with the lubricating and/or fat liquoring steps involved in the sourcing of the materials described herein. Finally, unlike animal leather, as the end product in the present invention is not a protein-based leather, toxic protein based crosslinking is not involved in the creation of the material.

Also included in the waste may be various filamentous Rhizopus fungal strains that are used for the production of enzymes, pharmaceuticals, citric acid, and other chemicals, that result in mycelial waste including: a) Aspergillus strains such as Aspergillus niger and Aspergillus oryzae, b) Penicillium nalgiovense and Penicillium chrysogenum, c) Emericella, d) Mucor, e) Mycosphaerella, f) Rhizopus, g) Quercus, h) Trichoderma harzianum, i) Saccharomyces spp., j) Aspergillus flavus, k) Aspergillus fumigatus, l) Aspergillus niger, m) Aspergillus ochraceus, n) Aspergillus terreus, o) Emericella nidulans, p) Mucor racemosus, q) Mycosphaerella tassiana, r) Penicillium chrysogenum, and s) Rhizopus stolonifer. Once sourced, the mycelium waste products are concentrated, diluted, and pH stabilized, which might change the pH. In some embodiments, an emulsifier is added that modulates the particle size and/or viscosity. In some embodiments, the hydroxyl groups are functionalized, deacetylated, combined with surfactant. In other embodiments, the miscibility (e.g., mixability) of the waste mycelium is modulated using a through a surfactant, or the like.

Also disclosed is a device for applying mycelium material to a base layer or substrate backer. In certain embodiments, the mycelium material is applied in a homogenous layer to a textile material, base layer, or substrate backer. In one example, said textile materials comprise synthetic fibers or natural fibers, for example a non-woven fabric. In a first step, mycelium material is applied to the fabric base via agglomerated methods (AM) (e.g., pressed methods, dehydrated methods, covalent methods, and the like). In certain embodiments, said mycelium material may take the form of a liquid, a spray, an emulsion, a gas, a solid, or a powder and may be sourced from fermentation waste streams (e.g., enzyme fermentation waste streams).

Said agglomerated methods (AM) may comprise use of mycelium agglomerates (MA; e.g., covalently bound MM, ionically bound MM, Van Der Waals bound MM, dehydrated MM, etc.), mycelium covalent agglomerates (MCA; covalent binding between MM particles), mycelium ionic agglomerates (MIA; ionic binding of agglomerates), mycelium heated agglomerates (MHA; heat press, heat formed methods), and Van Der Waals agglomerates (VDW; MM binding via Van Der Waals forces), and mycelium resonance agglomerates (MRA; resonance-stabilized agglomerates).

In certain embodiments, mycelium powder may be used to form MA. Said mycelium powder may be combined with cellulose and a polar liquid substrate to form a product with a moisture content between 1-25%, preferably between 1.5% and 18% and a grain size between 1μ-1 mm, particularly between 1-500. The use of powderized mycelium byproduct (MB) may also be particularly advantageous to form a variety of binders. In another embodiment, pigments or other additives are added to form water-based colors. Said pigments may include polar dyes with colors ranging across the visible spectrum (e.g., wavelengths from 380 to 700 nanometers). In another embodiment, additional coagulating additives are applied. In order to fix the applied material to the fabric base, an additional layer of composite mycelium sludge made of mycelium polymers is formed.

The composite mycelium sludge is formed in aqueous solution, which may comprise dissolved pigments and water-based colors or coagulating solvents and coagulating additives. In certain embodiments, a laminate may be formed using MP and MB self-adhesion. This laminate comprises a first layer made of waste sourced mycelium (MP or MB), mediums for facilitating leveling, mediums for hardening, pigments, binders, cellulose, and the like. All of these materials may be applied to the base layer, which may consist of non-woven fabric, fabric made of natural fibers, jersey fabric, fabric made of polyester and the like.

In some embodiments, the dehydrated sludge comprises a powder. In certain embodiments, a powdering process for treating sludge is disclosed including such steps as filtering, centrifuging, optional heating (ranging from 80 degrees Fahrenheit to 350 degrees Fahrenheit), high-pressure (or vacuum) dewatering/desiccating, and/or grinding. A dewatering apparatus may be utilized that includes a continuous circulating mechanism, which is composed of multiple upper working positions adapted for heating and lower dewatering units adapted for physical extrusion of liquid. In other embodiments, dewatering and desiccating is achieved via chemical means. In one example, hydrated sludge is physically entrapped in a semipermeable vessel. Exterior to the vessel is an ionic solution or material (e.g., solid NaCl) that serves to establish an equilibrium imbalance, drawing water from the sludge interior into the high ionic strength exterior, thereby desiccating the interior sludge material.

In another embodiment, a fabric base, for example a non-woven fabric made of 100% viscose, is immersed in a solvent, which comprises a composition according to the invention, preferably a polymer from a renewable source based on a thermoplastic mycelium, dried mycelium MP or MB powder with cellulose, preferably powder from remains of the fruit industry, other plant substances in various colors and additives for coagulation. In certain embodiments, the method may include applying a decal/layer to a paper base, on the surface of which a negative relief image is applied. According to the invention, this relief image is applied to the composition and thus creates a natural structure. In other embodiments, the surface is refined/embossed by applying polymers based on waste sourced material, such as biological thermoplastic water-based mycelium.

The cultivation of fungal mycelium and/or fungal mycelium admixed with powdered sludge may also be performed in a fermenter in a conventional manner known to a skilled person. In another embodiment, fungal mycelium of sludge derivation is produced as a liquid cultivation using cultivation media components. Cultivation time in a fermenter may take up to several days depending on the fungal strain and the sludge source.

Powdered sludge can also be processed via press cake meal extraction. Sludge adapted to said processing may also be derived from side streams or residues obtained from various enzymatic processes, such as citrus side products, berry meal extraction, and berry press cake. Side streams and residues with low value can thus be converted to higher-value products instead of composting or providing as a feedstuff.

In other embodiments, a variety of bonding processes can be used, including but not limited to applying a heat or pressure activated adhesive layer in between portions of mycelium-based materials, as well as high-frequency welding. High-frequency welding embodiments may use a variety of welding materials known in the art. In other embodiments, a heat press may be used. Stitchless bonding of mycelium-based materials can be used in the production of consumer products such as apparel, accessories, footwear, furniture, sporting goods, electronic devices, and automotive interiors. As described below, the construction of a briefcase using said materials and processes is used to demonstrate the stitchless bonding system.

In the preferred embodiment, the method for creating stitchless bonding of fungal material provides a means of bonding mycelium to itself via an adhesive layer 206 by way of heating, forming, and pressing the fungal materials. This process overcomes the limitation of delamination when using leather materials. The present approach is carbohydrate-based rather than protein based. As a result, glycosidic bonds are formed rather than lipid-generating protein-protein bonds experienced in leather materials.

Further to the above, the construction of briefcase with leather like properties is used to demonstrate the novel method for stitchless bonding of mycelium material described herein. In certain embodiments, the stitchless bonding of the briefcase provides a waterproof, durable, consumer product with an elegant design. In certain embodiments, tools used to construct the briefcase include a laser cutter, heat press machine, roller cutter, small heat iron, roller laminator, and cutting plotter such as that from Zünd Swiss Cutting Systems. Further materials used to construct the briefcase may include untreated waste-sourced mycelium sheets, leathering-treated mycelium sheets, and darkened mycelium sheets.

In other embodiments, the briefcase material is composed of a Ganoderma mycelium biopolymer formed by the process described above. In some embodiments, Ganoderma mycelium biopolymer includes Ganoderma filter fibers forming honeycomb resembling structures with flexible structural components and high tensile strength. In other embodiments of the invention, electrostatic means such as cloth or bio surfaces maintaining a permanent dipole are employed to make the briefcase water-repellant or virus repellent (e.g., repelling charged biomolecules such as viral surface proteins). Because water itself maintains a permanent dipole, such electrostatic surfaces serve to effectively repel water droplets, and the necessarily water-soluble viral particles within them, utilizing electrostatic properties. In one embodiment, said effect on viruses is enhanced by genetically engineering the mycelium fibers (e.g., via CRISPR and/or standard techniques known in the art) to secrete broad spectrum antibodies, antiviral compounds, and/or upregulate the natural antiviral defenses of the mycobacterial system.

In other embodiments, any waste-source Ganoderma mycelium biopolymer made using the above methods may be utilized. The interwoven hyphae of the preferred embodiment exhibits similar tensile and hand-feel properties as would be found in standard leather briefcases. In some embodiments the mycomaterial may be wholly or partially embedded in, coated with, or penetrated with a permanent or semi-permanent layer of antiviral or antimicrobial particles such as those including copper, silver, titanium dioxide, citric acid, or the like. In some embodiments, the Ganoderma mycelium biopolymer is hydrated with glycerin or polyethylene glycol or similar compounds. In other embodiments, the Ganoderma mycelium biopolymer is configured to be in contact with a fabric. In still other embodiments, the Ganoderma or other mycomaterial may be pure, and in other embodiments the Ganoderma or other mycomaterial may be hydrated with a suitable adjuvant, such as glycerin or polyethylene glycol, where it has been tanned (so as to crosslink the molecules within the Ganoderma and potentially change its pore size), and where any of the above are also in contact with a fabric (a la our mycelium-fabric composite).

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and. arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description of the preferred embodiment of the present invention has been presented for the purpose of illustration and description. It is not intended to be exhaustive or to limit the invention to the precise form disclosed. Many modifications and variations and permutations are possible in light of the above teachings. It is intended that the scope of the present invention to not be limited by this detailed description, but by the claims and the equivalents to the claims appended hereto.

What is claimed is:

1. A bonded fungal material composite comprising:
a plurality of waste-sourced mycelium substrates;
a bonding agent for crosslinking the plurality of waste-sourced mycelium substrates thereby providing a durable bond between each of the plurality of waste-sourced mycelium substrates;
a mold in the form of a panel for determining a geometric shape of the plurality of waste-sourced mycelium substrates, the mold being incubated thereby allowing the plurality of waste-sourced mycelium substrates to form a waste-sourced mycelium network that binds each of the plurality of waste-sourced mycelium substrates and the bonding agent together, solidifying slowly into the geometric shape of a plurality of waste-sourced mycelium substrates being cast within;
an adhesive layer for bonding the plurality of waste-sourced mycelium substrates within itself thereby enabling the formation of a solid continuous mycelium layer of the waste-sourced mycelium substrates; and
a drying chamber for enabling the dehydration of the plurality of waste-sourced mycelium substrates in a bonded state thereby retarding further growth of the plurality of waste-sourced mycelium substrates;
whereby the bonding agent does not expose to degradation thereby allowing durable and long-lasting bond between the plurality of waste-sourced mycelium substrates resulting in a stronger and more resilient bonded fungal material composite.

2. The bonded fungal material composite of claim 1 wherein the bonding agent signifies a cellulose-based material that provides self-adhesion of mycelium products.

3. The bonded fungal material composite of claim 1 wherein the plurality of waste-sourced mycelium substrates is desiccated and processed into a desiccated mycelium powder form or other suitable form for mixing with the cellulose-based material.

4. The bonded fungal material composite of claim 1 wherein a mixture of desiccated mycelium powder and cellulose-based material is subjected to heating and pressing to form a strong and durable waste-sourced fungal material composite.

5. The bonded fungal material composite of claim 1 wherein the bonding between the plurality of waste-sourced mycelium substrates does not require any mechanical means to hold the plurality of waste-sourced mycelium substrates together.

6. The bonded fungal material composite of claim 1 wherein the bonding agent is applied to the plurality of waste-sourced substrates, which is then shaped and cured to form the waste-sourced fungal material composite.

7. The bonded fungal material composite of claim 1 wherein the composite is carbohydrate-based and does not rely on the oils or other organic compounds that cause delamination.

8. The bonded fungal material composite of claim 1 further utilizing a plurality of mycelium materials sourced from fermentation waste streams.

9. The bonded fungal material composite of claim 1 wherein a portion of the plurality of mycelium material is attached to one or more portions of another mycelium material without the need for sewing, stitching, stapling or other mechanical means.

10. The bonded fungal material composite of claim 1 wherein the plurality of waste-sourced mycelium substrates is biodegradable and serves as a sustainable alternative to animal leather in various applications.

11. A method for creating stitchless bonding of fungal material composite, the method comprising the steps of:
a) providing a plurality of waste-sourced mycelium substrates;
b) processing the plurality of waste-sourced mycelium substrates utilizing a desiccation process, thereby removing excess moisture from the plurality of waste-sourced mycelium substrates;
c) mixing the plurality of waste-sourced mycelium substrates with a bonding agent in a mold and subjecting to a heating and pressing process to form a plurality of waste-sourced fungal material composite;
d) applying an adhesive layer to the plurality of waste-sourced fungal material composite thereby enabling the formation of a solid continuous layer of the plurality of waste-sourced fungal material composite;
e) forming the plurality of waste-sourced fungal material composite into a desired shape by applying a heat and pressing process to the plurality of waste-sourced fungal material composite;
f) enabling dehydration to prevent further growth of the plurality of waste-sourced fungal material composite utilizing a drying chamber.

12. The method of claim 11 wherein the bonding between the plurality of waste-sourced mycelium substrates does not require any mechanical means to hold the plurality of waste-sourced mycelium substrates together.

13. The method of claim 11 wherein the bonding agent is applied to the plurality of waste-sourced substrates, which is then shaped and cured to form the plurality of waste-sourced fungal material composite.

14. The method of claim 11 wherein a portion of the plurality of mycelium material is attached to one or more portions of another mycelium material without the need for sewing, stitching, stapling or other mechanical means.

15. The method of claim 11 wherein the plurality of waste-sourced fungal material composite is carbohydrate-based as the plurality of waste-sourced fungal material composite does not rely on the oils or other organic compounds that causes delamination.

16. The method of claim 11 wherein the method utilizes a plurality of mycelium materials sourced from fermentation waste streams.

17. The method of claim 11 wherein the plurality of waste-sourced mycelium substrate is biodegradable and serves as a sustainable alternative to animal leather in various applications.

18. A method for creating stitchless bonding of fungal composite, the method comprising the steps of:
a) providing a plurality of waste-sourced mycelium substrates in a desiccated form;
b) providing a bonding agent for crosslinking the plurality of waste-sourced mycelium substrates;
c) mixing the plurality of waste-sourced mycelium substrates with the bonding agent in a mold to form a plurality of waste-sourced fungal material composite mixture;
d) applying a pressure activated adhesive layer to the plurality of waste-sourced fungal material composite thereby forming a geometric shaped plurality of waste-sourced fungal material composite.

19. The method of claim 18 wherein the plurality of waste-sourced mycelium substrates is biodegradable and serves as a sustainable alternative to animal leather in various applications.

20. The method of claim 18 wherein the method is used for producing durable mycelium-based products, including but not limited to apparel, accessories, footwear, furniture, sporting goods, electronic devices, and automotive interiors, without the need for sewing, stitching, stapling, or other mechanical means.
